(19) United States
(12) Patent Application Publication
(10) Pub. No.: US 2019/0152800 A1
(43) Pub. Date: May 23, 2019

(54) Chakra Crystal Water

(71) Applicant: Nattalia Genao, Flushing, NY (US)

(72) Inventor: Nattalia Genao, Flushing, NY (US)

(21) Appl. No.: 16/198,685

(22) Filed: Nov. 21, 2018

Related U.S. Application Data
(60) Provisional application No. 62/590,256, filed on Nov. 22, 2017.

(51) Int. Cl. C02F 1/00; B65D 23/10; B65D 23/08; B65D 23/14; B65D 39/00; B65D 47/06; B65D 53/02; A47J 31/00

(52) U.S. Cl. CPC C02F 1/005; B65D 23/104; B65D 23/0807; B65D 23/14; C02F 2307/02; B65D 47/06; B65D 53/02; A47J 31/005; B65D 39/0052

(57) ABSTRACT

An improved water bottle comprising a variety of New Age mind-and-body healing and balancing elements such as therapeutic crystals, energy symbols, and chakra stones in the design and construction of a premium and unique, reusable bottle.

### CROSS-REFERENCE TO RELATED APPLICATION

The present application is related to and claims priority from prior provisional application Ser. No. 62/590,256, filed Nov. 22, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of water filtration devices and more specifically relates to an improved water bottle comprising a variety of New Age mind-and-body healing and balancing elements such as therapeutic crystals, energy symbols, and chakra stones in the design and construction of a premium and unique, reusable bottle.

### 2. Description of the Related Art

Consider, for example, the number of consumers who, dissatisfied with the mind-body duality found in Western medicine and religious traditions, have become adherents of “New Age” practices, beliefs, and techniques arising from age-old Eastern traditions—practices, beliefs, and techniques ranging from yoga to healing crystals, mind-body energizing and balancing chakra stones, and mindfulness meditation. So popular are these New Age beliefs and practices that, according to some estimates, as much as 20 percent of the populace hold and practice them. One New Age belief, popularized by a Japanese researcher named Masoru Emoto, suggests that water, when subjected to positive thought, words, music, symbols, and emotion, responds positively—and when frozen after such exposure, forms more perfect ice crystals than it otherwise would. Inspired by Dr. Emoto's work, the invention to be introduced and explored in the course of this report would combine several elements of New Age mind-body healing, balancing, and energization to offer consumers a unique product indeed—one they could use every day, anywhere, to enjoy drinking more purified, energizing water.

Various attempts have been made to solve problems found in water filtration device art. Among these are found in: U.S. Publication No. 2006/0034940 to Lynda Bell; U.S. Publication No. 2014/0158639 to Glen B. Caulkins; U.S. Pat. No. 6,013,180 to Wei-Renn Wang. This prior art is representative of water filtration and energizing devices.

Ideally, an improved water bottle should be user-friendly and safe in-use and, yet would operate reliably and be manufactured at a modest expense. Thus, a need exists for an improved water bottle comprising a variety of New Age mind-and-body healing and balancing elements such as therapeutic crystals, energy symbols, and chakra stones in the design and construction of a premium and unique, reusable bottle and to avoid the above-mentioned problems.

### BRIEF SUMMARY OF THE INVENTION

In view of the foregoing disadvantages inherent in the known water filtration devices art, the present invention provides a novel Improved Water Bottle (Entitled the Chakra Crystal Water). The general purpose of the present invention, which will be described subsequently in greater detail is to provide an improved water bottle comprising a variety of New Age mind-and-body healing and balancing elements such as therapeutic crystals, energy symbols, and chakra stones in the design and construction of a premium and unique, reusable bottle.

An improved water bottle comprising: a main body; a lid; a plurality of crystals; a sleeve; and a piece of paper. The main body includes: bottom wall; at least one side wall including a symbol engraved thereon; an open top portion; and interior volume. Wherein the at least one side wall extends upwardly from the bottom wall. Wherein the bottom wall and the at least one side wall form an interior volume. Wherein the lid is adapted to removably close the open top portion.

Wherein the plurality of crystals are located upon the bottom wall inside the interior volume. Wherein the sleeve is attached to an outer surface of the at least one side wall and is adapted to releasably hold a piece of paper therein. Wherein the piece of paper is adapted to have an inscription written thereon and removably placed within the sleeve. Wherein the symbol and the plurality of crystals are adapted to enhance the wellbeing of a person drinking from the improved water bottle.

The present invention holds significant improvements and serves as an Improved Water Bottle (Entitled the Chakra Crystal Water). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Water Bottle (Entitled the Chakra Crystal Water), constructed and operative according to the teachings of the present invention.

FIG. 1 shows a perspective view illustrating a improved water bottle according to an embodiment of the present invention.

FIG. 2 is a perspective view illustrating the improved water bottle having a lid includes an infuser according to an embodiment of the present invention of FIG. 1.

FIG. 3 is a perspective view illustrating another the improved water bottle having a Chakra stone and carrying strap according to an embodiment of the present invention of FIG. 1.

FIG. 4 is a perspective view illustrating the improved water bottle without the lid covering the open top portion according to an embodiment of the present invention of FIG. 1.

FIG. 5 is a perspective view illustrating various chakra stones of the improved water bottle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a water filtration device and more particularly to an Improved Water Bottle (Entitled the Chakra Crystal Water). The general purpose of the present invention, which will be described subsequently in greater detail is to provide an improved water bottle comprising a variety of New Age mind-and-body healing and balancing elements such as therapeutic crystals, energy symbols, and chakra stones in the design and construction of a premium and unique, reusable bottle

Generally speaking, the Chakra Crystal Waters comprises a specially designed product line of reusable glass water bottles, produced in two sizes and featuring healing crystals, symbols, and chakra stones in their design and construction.

The Chakra Crystal Waters would be produced in two sizes: one 60-ounce and one 18-ounce; and the bottles, while likely produced in shatterproof glass, might alternatively be produced in food-grade stainless steel. The large Chakra Crystal Waters would likely be styled in the form of a carafe, decanter, or pitcher, for filling glasses, while the smaller Chakra Crystal Waters would be a personal drinking bottle, including a handle and adjustable carrying strap. Each of the two Chakra Crystal Waters bottles would feature, as their base, a chakra stone or healing crystal. These would be salt-free, iron-free minerals, non-toxic and compatible with water, such as amethyst, citrine, quartz, rose quartz, rainbow obsidian, or lapis lazuli; and the chakra stones would be engraved with a variety of symbols sacred to the various chakras.

There are seven major chakras, or spiral bands of energy, which occupy areas between the base of the spine and the crown of the head; and there are additional chakras located below the feet and above the head. These chakras are associated with specific crystals and symbols, and are intended to provide energy and balance to their specific areas. The Chakra Crystal Waters bottles would also be engraved with a variety of age-old, sacred geometric symbols: the Reiki symbol for energy; the Eye of Horus symbol for wisdom, prosperity, and spiritual protection; the Spiral Sun symbol for the motion of the universe and healing power; the Dream Catcher for ensuring good dreams. An “expression pocket” or sleeve on the neck of the Chakra Crystal Waters bottles would permit users to write and insert a slip of paper with a word or two precious to them—“wisdom,” perhaps, or “energy” or “patience.” The watertight, gasketed lids of the Chakra Crystal Waters bottles would also feature embedded “crystal infusers” designed to act upon, purify, and energize the contained water.

Completely unique and stylishly attractive in design, the Chakra Crystal Waters would provide a drinking-water vessel that will promote, enhance, energize, and purify the benefits of drinking water. Clever in conception, and combining several distinct New Age phenomena into a single product for daily, regular use, the Chakra Crystal Waters bottles should find a wide and most enthusiastic market response, both within America and around the world.

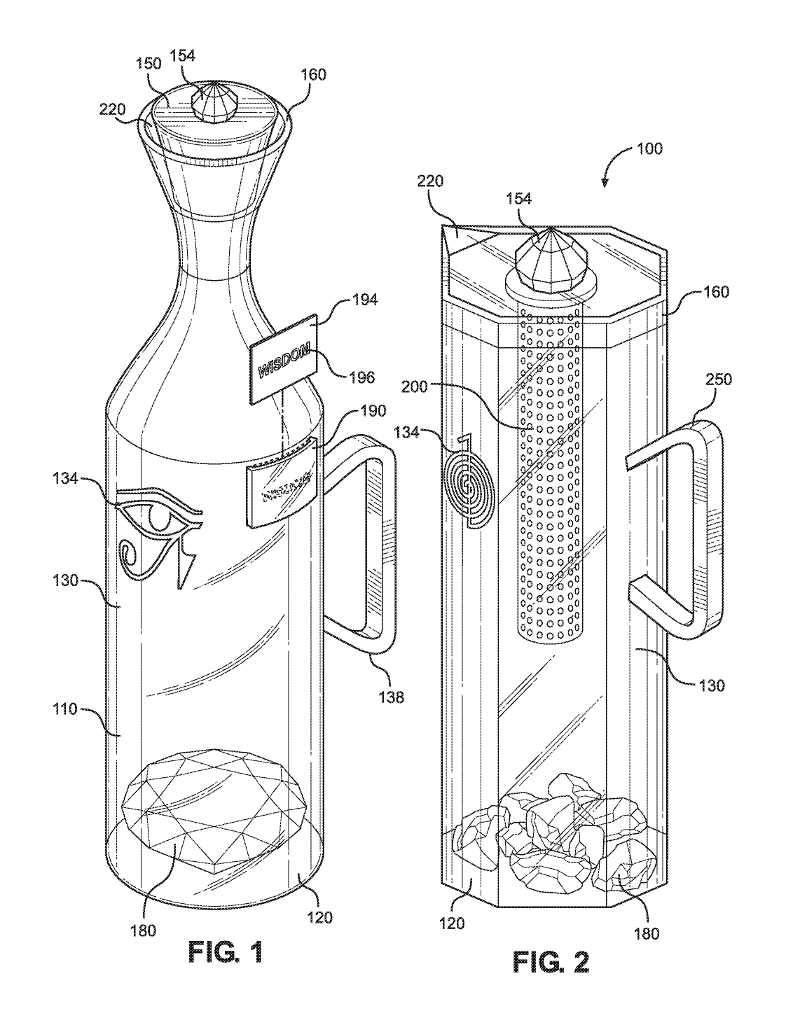

Referring to the drawings by numerals of reference there is shown in FIGS. 1-4, perspective views illustrating improved water bottle 100 according to an embodiment of the present invention.

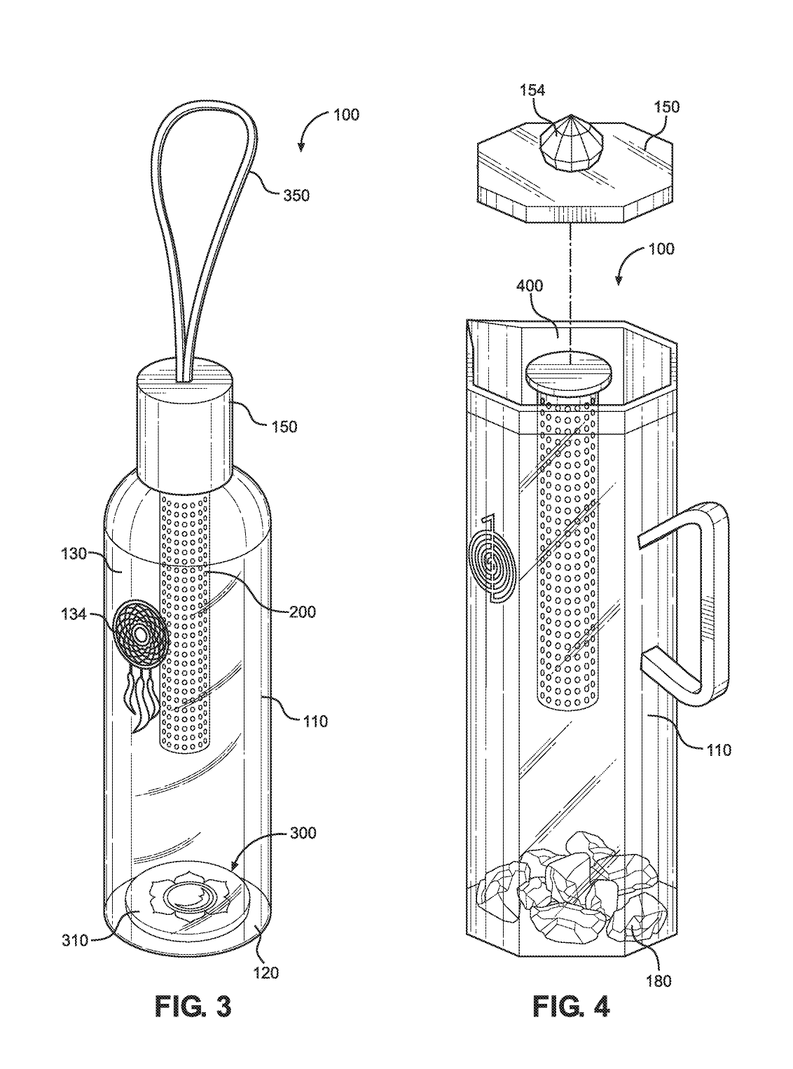

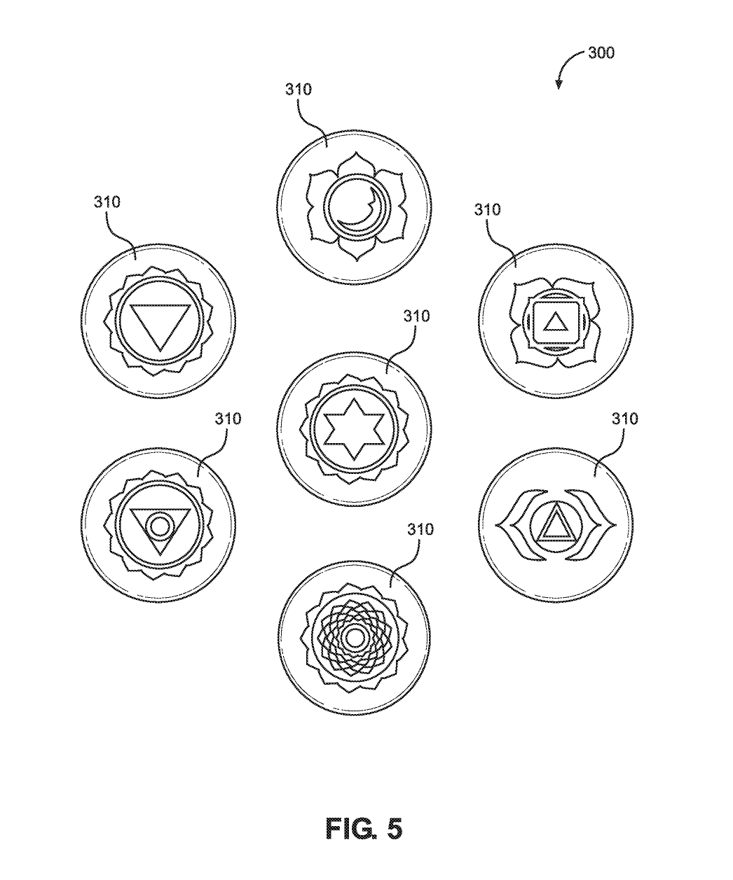

Improved water bottle 100 comprises: main body 110; lid 150; plurality of crystals 180; sleeve 190; and piece of paper 194. Main body 110 includes: bottom wall 120; at least one side wall 130 including symbol 134 engraved thereon; open top portion 400; and interior volume 410. Wherein at least one side wall 130 extends upwardly from bottom wall 120. Wherein bottom wall 120 and at least one side wall 130 form interior volume 410 as shown in FIG. 4. Wherein interior volume 410 of main body 110 is formed and adapted to hold 60 ounces of liquid as shown in FIGS. 1 and 2. Wherein interior volume 410 of main body 110 is formed and adapted to hold 18 ounces of liquid as shown in FIG. 3. Wherein main body 110 may be formed from glass. Wherein main body 110 may be formed from stainless steel. Improved water bottle 100 further comprising Chakra stone 300 having symbol 310 engraved thereon and located upon bottom wall 120 inside interior volume 410 as shown in FIG. 3. FIG. 5 shows various Chakra stone 300 having symbol 310 that may be located upon bottom wall 120 inside interior volume 410.

Wherein lid 150 includes infuser 200 attached thereto as shown in FIG. 2. Wherein lid 150 includes crystal 154 attached thereto. Wherein lid 150 includes gasket 160 attached thereto adapted to seal closed interior volume 410. Wherein lid 150 includes adjustable carrying strap 350 attached thereto.

Improved water bottle 100 further comprising handle 250 attached to an outer surface of at least one side wall 130. Improved water bottle 100 further comprising carrying strap 138 attached to an outer surface of at least one side wall 130. Wherein one of at least one side wall 130 is formed including spout 220 adapted to allow liquid to pass therethrough even when lid 150 has closed open top portion 400. Wherein lid 150 is adapted to removably close open top portion 400.

Wherein plurality of crystals 180 are located upon bottom wall 120 inside interior volume 410. Wherein crystals 180 are chosen from a group of crystals consisting of amethyst, citrine, quartz, rose quartz, rainbow obsidian, and lapis lazuli.

Wherein sleeve 190 is attached to an outer surface of at least one side wall 130 and is adapted to releasably hold piece of paper 194 therein. Wherein piece of paper 194 is adapted to have inscription 196 written thereon and removably placed within sleeve 190. Wherein inscription 196 is chosen from a group of inscriptions consisting of the words “wisdom”, “perhaps”, “energy”, and “patience”.

Wherein symbol 134 located on at least one side wall 130 and plurality of crystals 180 are adapted to enhance the wellbeing of a person drinking from improved water bottle 100. Wherein symbol 310 engraved upon Chakra stone 300 is chosen from a group of symbols consisting of the Reiki symbol for energy, the Eye of Horus symbol for wisdom, prosperity, and spiritual protection, the Spiral Sun symbol for the motion of the universe and healing power, and the Dream Catcher for ensuring good dreams as shown in FIG. 5.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved water bottle comprising:
a main body including:
bottom wall;
at least one side wall including:
a symbol engraved thereon; and
wherein said at least one side wall extends upwardly from said bottom wall; and
an open top portion;
wherein said bottom wall and said at least one side wall form an interior volume;
a lid;
wherein said lid is adapted to removably close said open top portion;
a plurality of crystals;
wherein said plurality of crystals are located upon said bottom wall inside said interior volume;
a sleeve;
wherein said sleeve is attached to an outer surface of said at least one side wall and is adapted to releasably hold a piece of paper therein; and
a piece of paper;
wherein said piece of paper is adapted to have an inscription written thereon and removably placed within said sleeve;
wherein said symbol and said plurality of crystals are adapted to enhance the wellbeing of a person drinking from said improved water bottle.

2. The improved water bottle of claim 1, wherein said crystals are chosen from a group of crystals consisting of amethyst, citrine, quartz, rose quartz, rainbow obsidian, and lapis lazuli.

3. The improved water bottle of claim 1, wherein said inscription is chosen from a group of inscriptions consisting of the words “wisdom”, “perhaps”, “energy”, and “patience”.

4. The improved water bottle of claim 1, wherein said main body is formed from glass.

5. The improved water bottle of claim 1, wherein said main body is formed from stainless steel.

6. The improved water bottle of claim 1, further comprising a Chakra stone having a symbol engraved thereon and located upon said bottom wall inside said interior volume.

7. The improved circuit breaker system of claim 6, wherein said symbol engraved upon said Chakra stone is chosen from a group of symbols consisting of the Reiki symbol for energy, the Eye of Horus symbol for wisdom, prosperity, and spiritual protection, the Spiral Sun symbol for the motion of the universe and healing power, and the Dream Catcher for ensuring good dreams.

8. The improved water bottle of claim 1, wherein said interior volume of said main body is formed and adapted to hold 60 ounces of liquid.

9. The improved water bottle of claim 1, wherein said interior volume of said main body is formed and adapted to hold 18 ounces of liquid.

10. The improved water bottle of claim 1, further comprising a handle attached to an outer surface of said at least one side wall.

11. The improved water bottle of claim 1, further comprising a carrying strap attached to an outer surface of said at least one side wall.

12. The improved water bottle of claim 1, wherein one of said at least one side wall is formed including a spout adapted to allow liquid to pass therethrough even when said lid has closed said open top portion.

13. The improved water bottle of claim 12, wherein said lid includes an infuser attached thereto.

14. The improved water bottle of claim 1, wherein said lid includes a crystal attached thereto.

15. The improved water bottle of claim 1, wherein said lid includes a gasket attached thereto adapted to seal closed said interior volume.

16. The improved water bottle of claim 1, wherein said lid includes an adjustable carrying strap attached thereto.
